(19) United States
(12) Patent Application Publication
(10) Pub. No.: US 2025/0171346 A1
(43) Pub. Date: May 29, 2025

(54) APPARATUS FOR MANUFACTURING OPTICAL FIBER PREFORM, METHOD FOR MANUFACTURING OPTICAL FIBER PREFORM, OPTICAL FIBER PREFORM AND OPTICAL FIBER

(71) Applicant: FURUKAWA ELECTRIC CO., LTD., Tokyo (JP)

(72) Inventors: Toshiyuki ASAI, Tokyo (JP); Mitsuhiro KAWASAKI, Tokyo (JP)

(73) Assignee: FURUKAWA ELECTRIC CO., LTD., Tokyo (JP)

(21) Appl. No.: 18/965,014

(22) Filed: Dec. 2, 2024

Related U.S. Application Data
(63) Continuation of application No. PCT/JP2023/025183, filed on Jul. 6, 2023.

(30) Foreign Application Priority Data
Jul. 21, 2022 (JP) 2022-116690

(51) Int. Cl. C03B 37/012

(52) U.S. Cl. CPC C03B 37/01208; C03B 37/01257; C03B 37/0126; C03B 2203/42

(57) ABSTRACT

The present invention intends to reduce unevenness on a surface of an optical fiber preform. The apparatus for manufacturing an optical fiber preform including a support portion rotating a core rod at a rotation speed r around a rotation axis of the core rod extending in a longitudinal direction of the core rod and at least one burner array including N sets (N is an integer of 2 or more) of burners provided at intervals of a distance d and a material ejection port, and moving around the core rod at a speed v in the longitudinal direction to form a porous glass portion on an outer periphery of the core rod. A rotation number (L+x) of the core rod when the burner array moves the distance d in the longitudinal direction is represented by rd/v=L+x where the L is an arbitrary natural number and the offset x is greater than −0.5 and less than or equal to 0.5, an absolute value of the offset x is greater than 2/(2N+1) and less than 3/(3N−1).

### CROSS-REFERENCE TO RELATED APPLICATIONS

This application is a continuation application of International Application No. PCT/JP2023/025183, filed Jul. 6, 2023, which claims the benefit of Japanese Patent Application No. 2022-116690, filed Jul. 21, 2022, both of which are hereby incorporated by reference herein in their entirety.

### BACKGROUND OF THE INVENTION

### Field of the Invention

The present invention relates to an apparatus for manufacturing an optical fiber preform, a method for manufacturing the optical fiber preform, the optical fiber preform and an optical fiber.

### Description of the Related Art

In recent years, in a manufacturing process of an optical fiber preform, a manufacturing method for an optical fiber preform has been proposed in which unevenness of a surface of the optical fiber preform is reduced to improve circularity of the optical fiber preform. The method for manufacturing an optical fiber preform described in Japanese Patent Application Laid-Open No. 2006-199526 includes a step of reducing unevenness on the surface of the optical fiber preform by defining a ratio between a moving speed of a burner for depositing glass particles on a core rod which is a starting material of the optical fiber preform and a rotation speed of the core rod.

### SUMMARY OF THE INVENTION

However, the method for manufacturing the optical fiber preform described in Japanese Patent Application Laid-Open No. 2006-199526 merely defines the relationship between the moving speed of one burner and the rotation speed of the core rod. When a plurality of burners are used in the technique described in Japanese Patent Application Laid-Open No. 2006-199526, the trajectories of flames of the plurality of burners overlap each other, and unevenness is generated on a surface of the optical fiber preform.

The present invention has been made in view of the above and intends to reduce unevenness on a surface of an optical fiber preform when a plurality of burners are used.

According to one aspect of the present invention, provided is an apparatus for manufacturing an optical fiber preform including a support portion rotating a core rod at a rotation speed r around a rotation axis of the core rod extending in a longitudinal direction of the core rod and at least one burner array including N sets (N is an integer of 2 or more) of burners provided at intervals of a distance d and a material ejection port, and moving around the core rod at a speed v in the longitudinal direction to form a porous glass portion on an outer periphery of the core rod. A rotation number (L+x) of the core rod when the burner array moves the distance d in the longitudinal direction is represented by,

$$\frac{r d}{v} = L + x$$

where the L is an arbitrary natural number and an offset x is greater than −0.5 and less than or equal to 0.5, an absolute value of the offset x is represented by,

$$\frac{2}{2 N + 1} < \vert x \vert < \frac{3}{3 N - 1} .$$

According to the present invention, it is possible to provide an apparatus for manufacturing an optical fiber preform capable of reducing unevenness of a surface of the optical fiber preform.

### BRIEF DESCRIPTION OF THE DRAWINGS

FIG. 1 is a side view of a deposition apparatus used for manufacturing an optical fiber preform according to a first embodiment of the present invention.

FIG. 2 is a block diagram of a control device for controlling the deposition apparatus according to the first embodiment of the present invention.

FIG. 3 is a side view of a burner array according to the first embodiment of the present invention.

FIG. 4A is a schematic diagram of an operation of the burner array according to the first embodiment of the present invention.

FIG. 4B is a schematic diagram of an operation of the burner array according to the first embodiment of the present invention.

FIG. 4C is a schematic diagram of an operation of the burner array according to the first embodiment of the present invention.

FIG. 4D is a schematic diagram of an operation of the burner array according to the first embodiment of the present invention.

FIG. 4E is a schematic diagram of an operation of the burner array according to the first embodiment of the present invention.

FIG. 4F is a schematic diagram of an operation of the burner array according to the first embodiment of the present invention.

FIG. 5 is a diagram illustrating a distance of a trajectory of a flame of the burner with respect to the manufacturing conditions of the optical fiber preform in the first embodiment of the present invention.

FIG. 6A is a developed view of the trajectory of the burner array formed on a side portion of the optical fiber preform according to the first embodiment of the present invention.

FIG. 6B is a developed view of the trajectory of the burner array formed on a side portion of the optical fiber preform according to the first embodiment of the present invention.

FIG. 6C is a developed view of the trajectory of the burner array formed on a side portion of the optical fiber preform according to the first embodiment of the present invention.

FIG. 6D is a developed view of the trajectory of the burner array formed on a side portion of the optical fiber preform according to the first embodiment of the present invention.

FIG. 7 is a diagram illustrating a distance of a trajectory of a flame of the burner with respect to the manufacturing conditions of the optical fiber preform in the first embodiment of the present invention.

FIG. 8A is a developed view of the trajectory of the burner array formed on a side portion of the optical fiber preform according to the first embodiment of the present invention.

FIG. 8B is a developed view of the trajectory of the burner array formed on a side portion of the optical fiber preform according to the first embodiment of the present invention.

FIG. 8C is a developed view of the trajectory of the burner array formed on a side portion of the optical fiber preform according to the first embodiment of the present invention.

FIG. 8D is a developed view of the trajectory of the burner array formed on a side portion of the optical fiber preform according to the first embodiment of the present invention.

FIG. 9 is a flowchart of a method for manufacturing the optical fiber preform and an optical fiber according to the first embodiment of the present invention.

FIG. 10A is a graph illustrating an outer diameter variation of the optical fiber preform of Example 1 in the first embodiment of the present invention.

FIG. 10B is a graph illustrating an outer diameter variation of the optical fiber preform of Example 2 in the first embodiment of the present invention.

FIG. 10C is a graph illustrating an outer diameter variation of the optical fiber preform of Comparative Example in the first embodiment of the present invention.

### DESCRIPTION OF THE EMBODIMENTS

Hereinafter, embodiments of the present invention will be described with reference to the drawings. Same reference numerals throughout the specification refer to same elements.

### First Embodiment

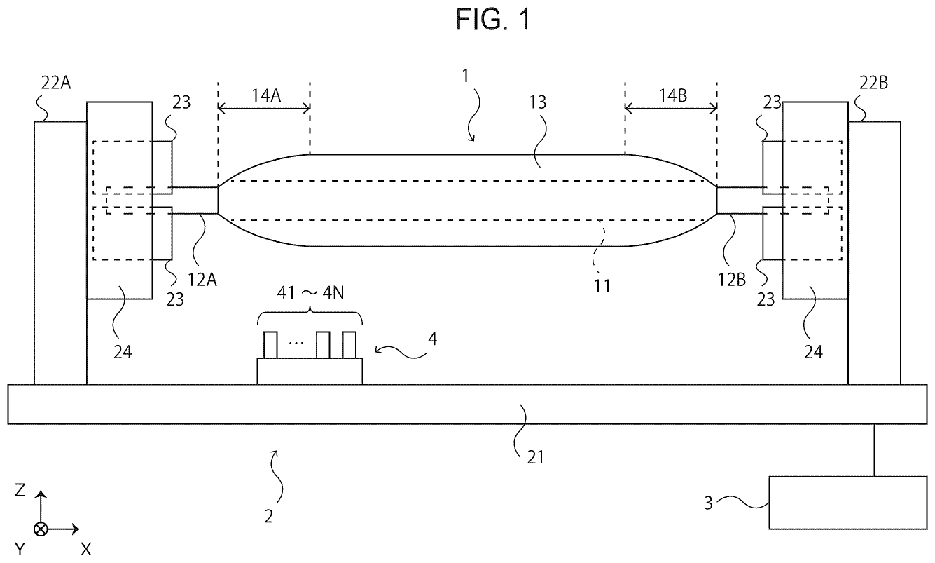

FIG. 1 is a side view of a deposition apparatus used for manufacturing an optical fiber preform according to an embodiment of the present invention. A core rod of the optical fiber preform 1 includes a core portion 11 and support portions 12A and 12B. The core portion 11 is a starting material of the optical fiber preform 1 and is formed of quartz glass or the like. The core portion 11 can be formed by heating and stretching a rod having a core and a cladding layer formed on an outer periphery of the core. The core portion 11 has a substantially cylindrical shape and may have, for example, a length of 4000 mm and a diameter of 60 mm. Glass particles are deposited on an outer periphery of a side portion of the core portion 11 in a deposition step described later to form the optical fiber preform 1.

The support portions 12A and 12B are support rods, and the support portions 12A and 12B are provided at both ends of the core portion 11, respectively. The support portions 12A and 12B are used to support the core portion 11 in a deposition step and a sintering step of glass particles. Like the core portion 11, the support portions 12A and 12B are made of quartz or the like. The support portions 12A and 12B have a substantially cylindrical shape and may have a length of 1000 mm and a diameter of 90 mm, for example. The length and diameter of the support portions 12A and 12B may be appropriately changed according to the length or diameter of the core portion 11, a thickness of a deposited glass particles, or the like.

The support portions 12A and 12B are jointed to the core portion 11 so that the support axes of the support portions 12A and 12B and the core axis of the core portion 11 are positioned on substantially the same line. The support portions 12A and 12B are weld-bonded to the core portion 11 using an oxyhydrogen burner or the like. The weld-bonding method is not limited thereto, and the weld-bonding may be performed using an electric furnace or the like.

A porous glass portion 13 is a layer of glass particles deposited on the core portion 11. The porous glass portion 13 is deposited on the core portion 11 by the deposition apparatus 2. The deposition method of the porous glass portion 13 may be, for example, a vapor phase axial deposition (VAD) method, an outside vapor deposition (OVD) method, or the like. The OVD method is a method in which the core portion 11 is held at both ends and glass particles are deposited in a horizontal direction on the side portions of the core portion 11. In the present embodiment, the porous glass portion 13 is deposited by the OVD method using a horizontal deposition apparatus.

The porous glass portion 13 includes tapered portions 14A and 14B. The tapered portions 14A and 14B are formed to have a predetermined length in the X direction. The predetermined length corresponds to a distance in the X direction from a burner at one end to a burner at the other end included in a burner array described later.

The deposition apparatus 2 includes a base 21, support portions 22A and 22B, a holding portion 23, a stress applying portion 24, a control device 3, and a burner array 4. The base 21 is a member that is a foundation of the deposition apparatus 2 and has a rectangular shape. The base 21 is installed substantially horizontally with respect to the ground plane. The base 21 extends in the longitudinal direction of the base 21 and includes a rail or the like provided below the core portion 11, and the support portions 22A and 22B and the burner array 4 are movable along the rail. In the present embodiment, a configuration including one rail and one burner array 4 is described, but a configuration including a plurality of rails and a plurality of burner arrays 4 may be used. In the case of a configuration including a plurality of rails and a plurality of burner arrays 4, the plurality of rails are preferably provided at a predetermined angle in the circumferential direction of the core portion 11. For example, in a case where three rails are provided, the three rails are provided at an angle of 120 degrees with respect to each other in the circumferential direction, and the burner array 4 is installed on each rail. In a plan view, a longitudinal direction of the base 21 is defined as an X direction, a lateral direction of the base 21 is defined as a Y direction, and a vertical direction of the base 21 is defined as a Z direction.

The support portions 22A and 22B have a columnar shape, face each other, and are provided on the upper portion of the base 21. That is, the support portion 22A is provided at one end portion of the base 21, and the support portion 22B is provided at the other end portion of the base 21. At least one of the support portions 22A and 22B is movable on the rail laid on the base 21. The support portions 22A and 22B include a rotary motor, a transmission, or the like that rotationally drive the core portion 11 via the support portions 12A and 12B.

The holding portion 23 and the stress applying portion 24 constitute a chuck, and are provided in the support portions 22A and 22B, respectively. The holding portion 23 is made of, for example, a metal such as steel use stainless (SUS), a heat-resistant fluororesin, or the like, and includes a plurality of claws that can approach or separate from each other. Holding holes are formed in the center of the plurality of claws so as to hold the support portions 12A and 12B.

The stress applying portion 24 is provided around the holding portion 23, and can apply stress to the holding portion 23. When the stress applying portion 24 applies stress to the holding portion 23, the plurality of claws are close to each other, and the diameter of the holding hole is reduced. Thus, the support portions 12A and 12B inserted into the holding holes are held by the holding portions 23.

The control device 3 is communicatively connected to the deposition apparatus 2 and controls the operation of the deposition apparatus 2 and the operation of the burner array 4. The control device 3 can control a rotation direction, a rotation speed and a magnitude of a stress of the stress applying portion 24 and a movement direction, a moving speed and a movement range in the X direction of the burner array 4 or the like when the deposition apparatus 2 rotationally drives the core portion 11.

The burner array 4 includes a plurality of burners 41 to 4N and are installed on a rail of the base 21. The burner array 4 moves on the rail in the X direction and can deposit glass particles on the core portion 11 rotating about the core axis. The burner 41 is a burner that blows glass particles onto the core portion 11, and is, for example, a burner that uses a gas containing hydrocarbon (methane) as a main component and oxygen or oxyhydrogen as fuel. The burner 41 includes a nozzle for supplying a flammable gas, a nozzle for supplying a supporting gas, a nozzle for supplying a glass material (a material ejection port), or the like. For example, the flammable gas may be a gas containing hydrogen or hydrocarbon as a main component, and the supporting gas may be oxygen. The glass material may be, for example, cyclic siloxane, SiCl₄, or the like. The burner 41 inputs a glass material into a flame, and generates glass particles by an oxidation/thermal decomposition reaction, a flame hydrolysis reaction, or the like. The plurality of burners 41 to 4N operate integrally. In this manner, the porous glass portion 13 is deposited on the outer periphery of the core portion 11 to form the optical fiber preform 1.

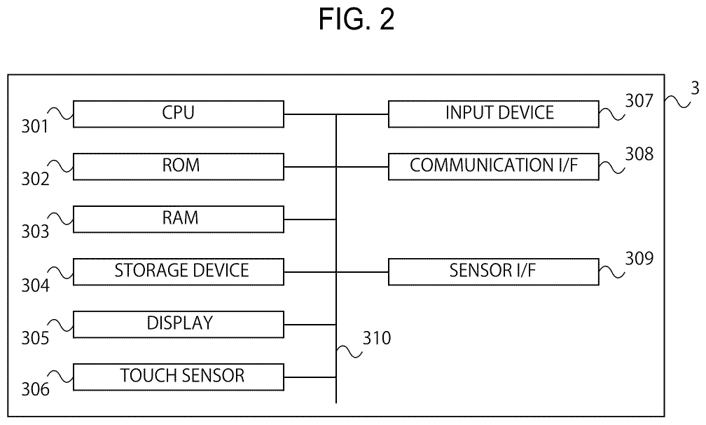

FIG. 2 is a block diagram of a control device for controlling the deposition apparatus according to the present embodiment. The control device 3 includes a central processing unit (CPU) 301, a read only memory (ROM) 302, a random access memory (RAM) 303, a storage device 304, a display 305, a touch sensor 306, an input device 307, a communication I/F 308, a sensor I/F 309, and a bus 310. The respective units are connected to each other via the bus 310.

The CPU 301 controls each unit of the deposition apparatus 2 and the burner array 4 by an application program. The ROM 302 is configured by a nonvolatile memory, and stores an application program for controlling each unit of the deposition apparatus 2 and the burner array 4. The RAM 303 provides a memory area necessary for the operation of the CPU 301. The storage device 304 includes a hard disk, a semiconductor memory, or the like.

The display 305 includes, for example, a liquid crystal display, an organic light emitting diode (OLED) display, and a light emitting diode (LED) display. The touch sensor 306 is disposed on a surface of the display 305. The touch sensor 306 includes a capacitive or resistive detection circuit. The input device 307 is a user I/F, and may be, for example, a keyboard, a mouse, or the like.

The communication I/F 308 is a communication unit that transmits and receives data, and communicably connects the control device 3 and the deposition apparatus 2. Communication between the control device 3 and the deposition apparatus 2 via the communication I/F 308 may be wired communication or wireless communication. A method of wireless communication may be, for example, third generation mobile communication, long term evolution (LTE), fourth generation mobile communication, fifth generation mobile communication, short-range wireless communication such as Bluetooth (registered trademark), wireless communication by wireless LAN connection such as Wi-Fi, or the like.

The sensor I/F 309 acquires various kinds of data from sensors included in the deposition apparatus 2 and stores the data in the storage device 304 or the like. The various data may be, for example, the ambient temperature and the ambient humidity of the optical fiber preform 1, the mass, the surface temperature, the surface roughness, the rotation direction, the rotation speed, the acceleration, the rotation angle of the optical fiber preform 1, the deposition amount of the porous glass portion 13, the position of the burner array 4, the flame temperature of the burners 41 to 4N, or the like.

The control device 3 receives control parameters of the deposition apparatus 2 and control parameters of the burner array 4 by an operation of an operator, and controls the deposition apparatus 2 and the burner array 4. In addition, the control device 3 may receive information from a sensor (not shown) provided in the deposition apparatus 2 via the sensor I/F 309, calculate a rotation direction, a rotation speed and a rotation angle of the rotating optical fiber preform 1 and a position of the burner array 4, or the like, and reflect the calculated information in control of the deposition apparatus 2 and the burner array 4.

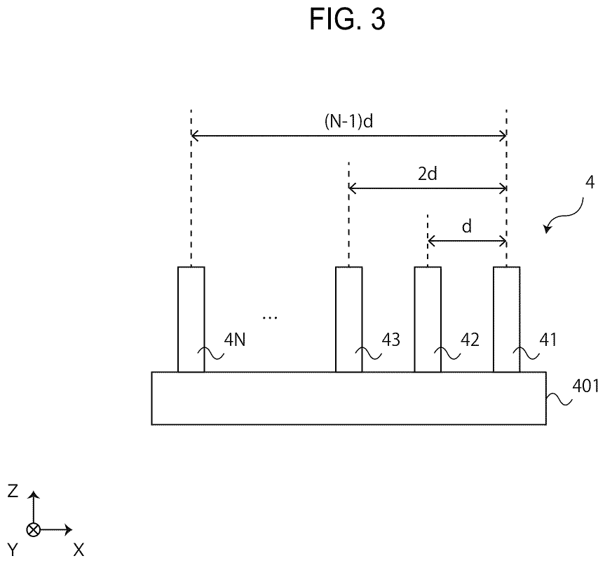

FIG. 3 is a side view of the burner array according to the present embodiment. The burner array 4 includes a burner base 401 and N burners 41 to 4N. Here, the number of burners N is an integer of 2 or more. The burner base 401 is movable in the X direction on the rail of the base 21. The burners 41 to 4N are installed substantially linearly on an upper portion of the burner base 401. The burner 41 and the burner 42 are installed at a distance d, and the burner 41 and the burner 43 are installed at a distance 2d. That is, the burners 41 to 4N are installed substantially linearly on the upper portion of the burner base 401, and a distance d is provided between adjacent burners. Therefore, the distance from the burner 41 to the burner 4N in the X direction is (N−1)d. The number N of burners and the distance d can be adjusted according to the length of the optical fiber preform 1, the desired deposition amount of the porous glass portion 13, the desired length of the tapered portions 14A and 14B, or the like. In the case of the configuration in which the plurality of rails and the plurality of burner arrays 4 are provided, the temperature of the flame in the burner array 4, the supply amounts of the flammable gas and the supporting gas, the supply amount of the glass material, the angle between the nozzle and the optical fiber preform 1, or the like can be independently controlled for each burner array 4.

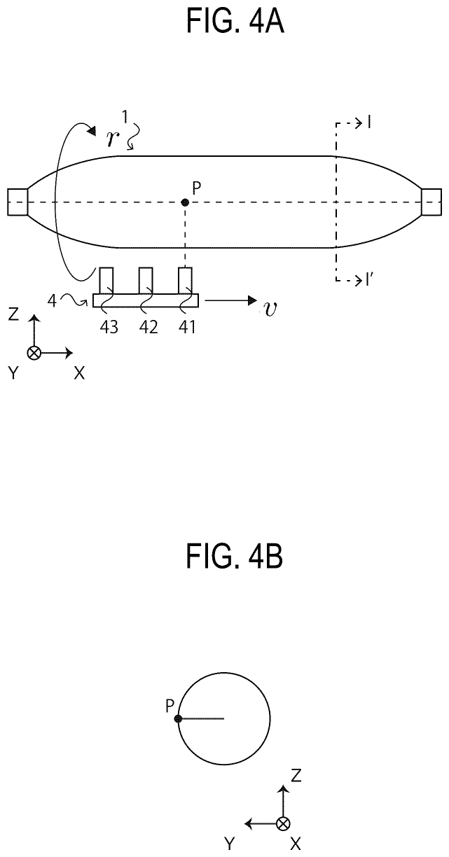

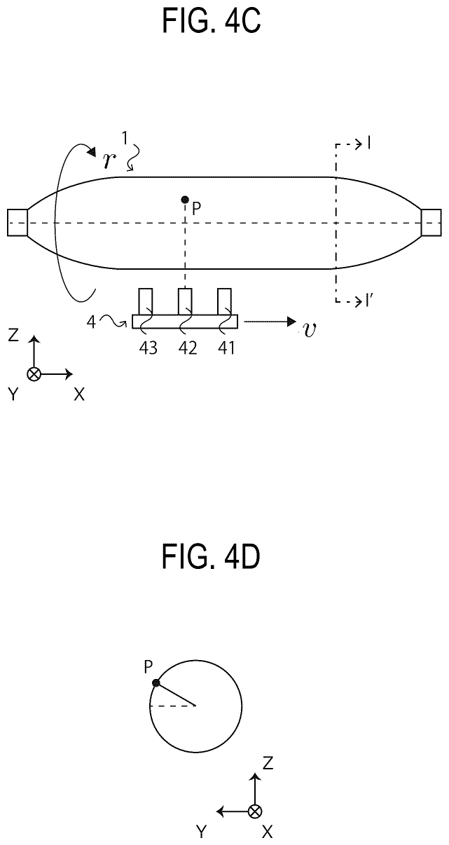

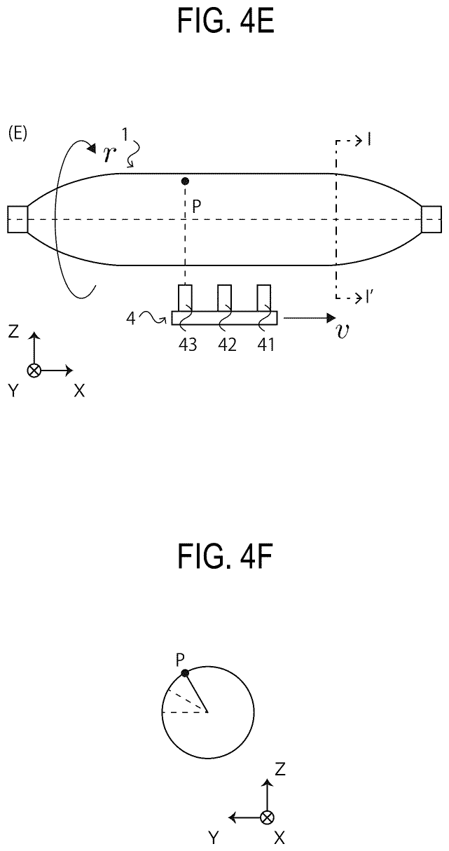

FIGS. 4A to 4F are schematic diagrams of the operation of the burner array in the present embodiment. FIGS. 4A, 4B, and 4E are side views of the optical fiber preform 1, and FIGS. 4B, 4D, and 4F are cross-sectional views of the optical fiber preform 1 taken along line I-I′ of FIGS. 4A, 4C, and 4E, respectively. The optical fiber preform 1 rotates at a rotation speed r [rpm] around the core axis of the core portion 11. The number of burners N is 3, and the burner array 4 includes three burners 41 to 43. The burner array 4 moves in the X direction at a moving speed v [mm/min] to deposit the porous glass portion 13 on the optical fiber preform 1. When the optical fiber preform 1 rotates (L+x) while the burner array 4 moves a distance d [mm] in the X direction, the relationship between the rotation speed r of the optical fiber preform 1 and the moving speed v of the burner array 4 can be expressed as follows.

$$\frac{ν}{r} = \frac{d}{L + x} \qquad ( 1 )$$

Here, L+x is the rotation number of the optical fiber preform 1 and can be set by the operator. The rotation number L is a natural number representing an integer part of the rotation number of the optical fiber preform 1, and the offset x is a parameter representing a decimal part of the rotation number of the optical fiber preform 1. For example, when L=5 and x=0.5, if the optical fiber preform 1 makes 5.5 rotations, the burner array 4 moves by a distance d in the X direction. The range of the offset x is set as follows.

$$- 0.5 < x \leq + 0.5$$

The rotation number L controls the cycle of the trajectory of the flame of the burner 41 in the X direction. When the rotation number L increases, the cycle of the trajectory of the flame of the burner 41 in the X direction decreases, and the density of the glass particles deposited on the side portions of the core portion 11 by the burners 41 to 4N increases. When the rotation number L becomes small, the cycle of the trajectory of the flame of the burner 41 in the X direction becomes large, and the density of the glass particles deposited on the side portions of the core portion 11 by the burners 41 to 4N becomes small. The rotation number L may be determined according to the number of burners N and the distance d between the burners, or may be determined according to the deposition density of the porous glass portion 13, the time required for the deposition process, or the like. In the step of depositing the glass particles, the rotation number L is not necessarily constant and can be appropriately changed. For example, it may be determined according to the deposition amount, the surface roughness, or the like of the porous glass portion 13. However, while the burner array 4 moves from one end to the other end of the optical fiber preform 1 and deposits the glass particles, it is desirable that the rotation number L is constant.

In FIGS. 4A and 4B, the trajectory of the flame of the burner 41 overlaps the point P on the side portion of the optical fiber preform 1. Since the burner 42 and the burner 43 are provided away from the burner 41 by the distance d and the distance 2d, respectively, the trajectory of the flame of the burner 42 and the trajectory of the flame of the burner 43 pass through positions away from the point P by the distance d and the distance 2d, respectively, in the X direction.

When the offset x≠0, in FIGS. 4C and 4D, when the burner array 4 moves by the distance d in the X direction, the optical fiber preform 1 rotates (L+x), and the trajectory of the flame of the burner 42 reaches the position of the point P in the X direction. At this time, since the point P reaches a position rotated by the offset x about the core axis from the position of the point P in FIG. 4B, the trajectory of the flame of the burner 42 does not overlap the point P. That is, the trajectory of the flame of the burner 42 passes through a position where the trajectory of the flame of the burner 41 is rotated about the core axis by the offset x. Therefore, the trajectory of the flame of the burner 42 does not overlap with the trajectory of the flame of the burner 41.

In FIGS. 4E and 4F, when the burner array 4 further moves by the distance d in the X direction, the optical fiber preform 1 further rotates (L+x), and the trajectory of the flame of the burner 43 reaches the position of the point P in the X direction. At this time, since the point P reaches a position rotated by the offset x about the core axis from the position of the point P in FIG. 4D, the trajectory of the flame of the burner 43 does not overlap the point P. That is, the trajectory of the flame of the burner 43 passes through a position where the trajectory of the flame of the burner 42 is rotated about the core axis by the offset x. Therefore, the trajectory of the flame of the burner 43 does not overlap the trajectory of the flame of the burner 41 and the trajectory of the flame of the burner 42.

Thus, the offset x controls the distance of the trajectory of the flame of the burners 41 to 4N. For example, when the offset x is 0, the flame trajectories of the burners 41 to 4N overlap each other. When all the flame trajectories of the burners 41 to 4N overlap, the unevenness of the surface of the optical fiber preform 1 may increase. Therefore, the value of the offset x is considered such that the trajectories of the flames of the burners 41 to 4N become equally spaced and the unevenness of the surface of the optical fiber preform 1 becomes small.

When the trajectory of the flame of the burner 41, the trajectory of the flame of the burner 42, and the trajectory of the flame of the burner 4N pass through the vicinity of the point P, the distance in the X direction between the point P and each trajectory of the flame is obtained. First, when the optical fiber preform 1 makes one rotation on the basis of the time when the trajectory of the flame of the burner 41 overlaps the point P, the trajectory of the flame of the burner 41 moves from the point P in the X direction by a distance d/(L+x) shown in the Equation (1). When the optical fiber preform 1 performs the L rotation, the trajectory of the flame of the burner 42 and the point P are positioned on substantially the same straight line in the X direction. At this time, the distance in the X direction between the trajectory of the flame of the burner 42 and the point P is expressed by the following equation.

$$\vert \frac{vL}{r} - d \vert = \vert \frac{dL}{L + x} - d \vert = \vert \frac{dx}{L + x} \vert \qquad ( 2 )$$

Similarly, when the optical fiber preform 1 the (N−1)L rotation, the trajectory of the flame of the burner 4N and the point P are positioned on substantially the same straight line in the X direction. At this time, the distance in the X direction between the trajectory of the flame of the burner 4N and the point P is expressed by the following equation.

$$\vert \frac{v ( N - 1 ) L}{r} - ( N - 1 ) d \vert = \vert - \frac{( N - 1 ) dx}{L + x} \vert \qquad ( 3 )$$

In the vicinity of the point P, the difference in distance in the X direction between the trajectory of the flame of the burner 41 and the trajectory of the flame of the burner 4N can be expressed by the difference between Equation (1) and Equation (3).

$$\frac{d}{L + x} - \vert - \frac{( N - 1 ) dx}{L + x} \vert = \frac{d - \vert ( N - 1 ) dx \vert}{L + x} \qquad ( 4 )$$

Here, when the offset x is ±1/(N−1), the value of Equation (4) becomes 0, and thus the trajectory of the flame of the burner 41 and the trajectory of the flame of the burner 4N overlap each other.

When the Equation (4) is divided by the Equation (2), the ratio of the distance between the trajectory of the flame of the burner 41 and the trajectory of the flame of the burner 42 and the distance between the trajectory of the flame of the burner 41 and the trajectory of the flame of the burner 4N is obtained.

$$\frac{d - \vert ( N - 1 ) dx \vert}{L + x} \times \vert \frac{L + x}{dx} \vert = \frac{d - \vert ( N - 1 ) dx \vert}{\vert dx \vert} = \frac{1 - ( N - 1 ) \vert x \vert}{\vert x \vert} \qquad ( 5 )$$

Here, when the offset x is ±1/N, the Equation (5) becomes 1, so that the distance between the trajectory of the flame of the burner 41 and the trajectory of the flame of the burner 42 becomes equal to the distance between the trajectory of the flame of the burner 41 and the trajectory of the flame of the burner 4N. Since the intervals between the trajectories of the flames of the burner 41 and the burner 42, the burner 42 and the burner 43, . . . , the burner 4(N−1) and the burner 4N are always equal to each other, all the trajectories of the flames are equal to each other, and the unevenness of the surface of the optical fiber preform is minimized. Therefore, the value of the offset x is preferably set to a value other than 0 and larger than −1/(N−1) and smaller than 1/(N−1), and more preferably set to ±1/N.

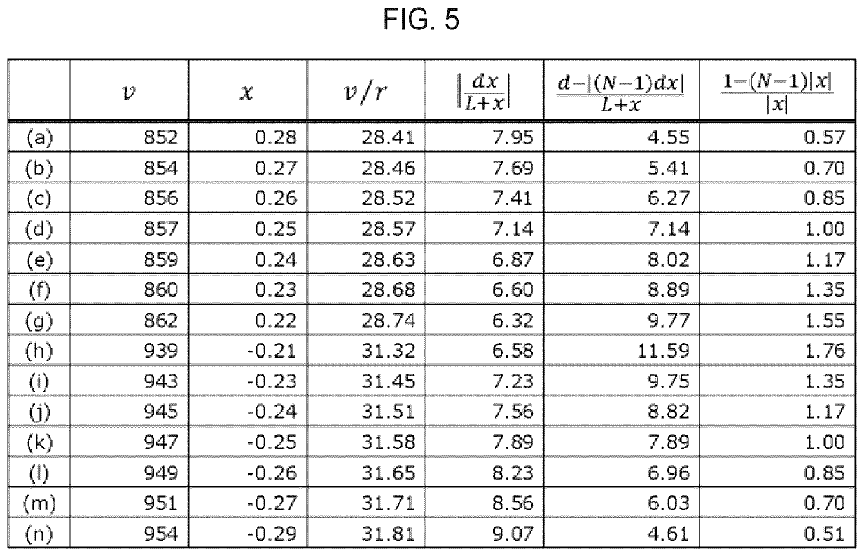

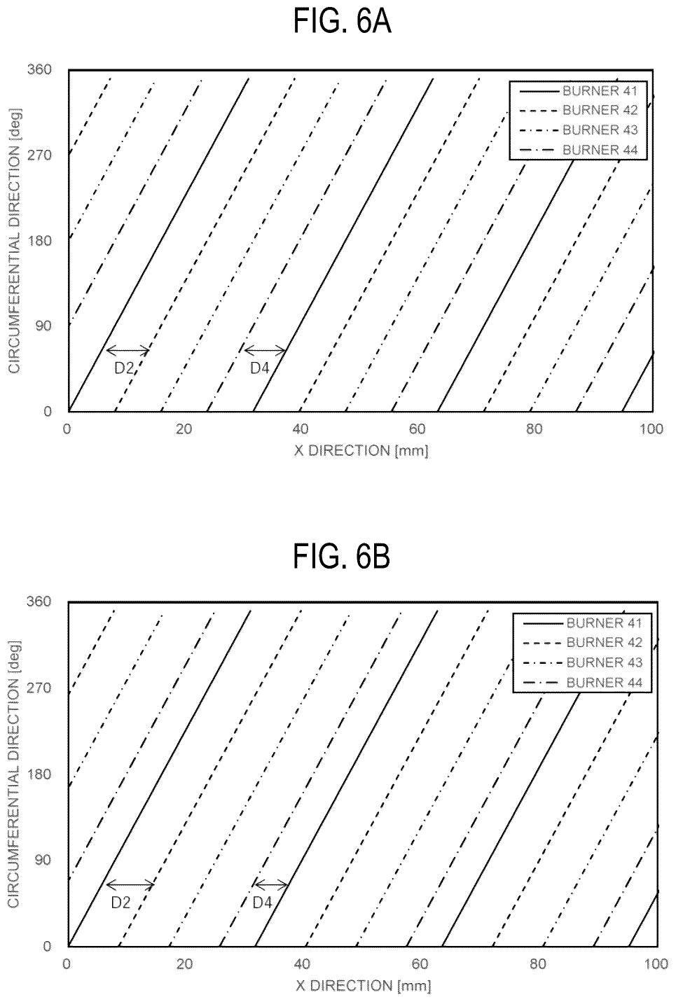

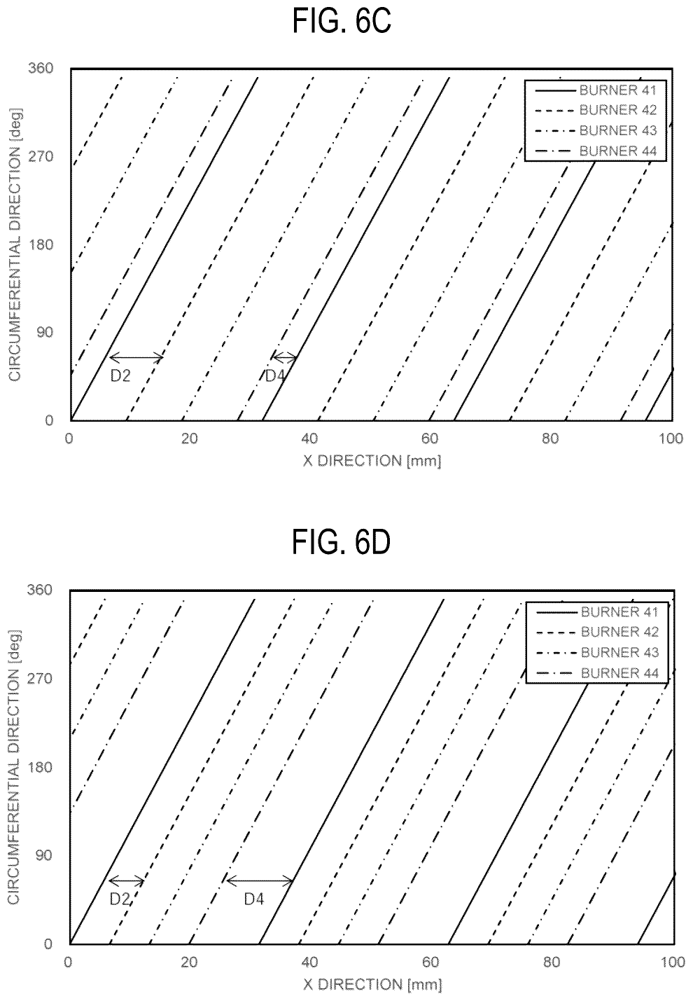

FIG. 5 is a diagram illustrating the distance of the trajectory of the flame of the burner with respect to the manufacturing conditions of the optical fiber preform in the present embodiment, and illustrates the value of the moving speed v [mm/min] of the burner array 4, the value of the offset x, the value of the moving distance v/r of the burner array 4 in the X direction when the optical fiber preform 1 makes one rotation, the value of Equation (2) (distance between the trajectory of the flame of the burner 41 and the trajectory of the flame of the burner 42), the value of Equation (4) (distance between the trajectory of the flame of the burner 41 and the trajectory of the flame of the burner 44), and the value of Equation (5), when the rotation number L=5, the number of burners N=4, the distance d=150 [mm] between the burners, and the rotation speed r=30 [rpm] of the optical fiber preform 1. FIGS. 6A to 6D are developed views of the trajectory of the flame of the burners 41 to 44 formed on the side portions of the optical fiber preform 1 in the present embodiment.

In FIG. 5, when the value of the offset x is 0.28 to 0.22 and −0.21 to −0.29, the moving speed v is 852 to 862 [mm/min] and 939 to 954 [mm/min], respectively. When the value of the offset x is 0.28 to 0.22 and −0.21 to −0.29, the distance by which the burner array 4 moves in the X direction when the optical fiber preform 1 makes one rotation is 28.41 to 28.74 [mm] and 31.32 to 31.81 [mm], respectively.

Condition (k) of FIG. 5 illustrates the values of Equations (2), (4), and (5) when the offset x=−0.25, and FIG. 6A illustrates a developed view of the trajectory of the flames of the burners 41 to 44 when the offset x=−0.25. In the condition (k) of FIG. 5, the values of the Equation (2) and the Equation (4) are both 7.89, and the value of the Equation (5) is 1.00. Therefore, the distance between the trajectory of the flame of the burner 41 and the trajectory of the flame of the burner 42 is equal to the distance between the trajectory of the flame of the burner 41 and the trajectory of the flame of the burner 44. In FIG. 6A, the distance D2 between the trajectory of the flame of the burner 41 and the trajectory of the flame of the burner 42 is equal to the distance D4 between the trajectory of the flame of the adjacent burner 44 and the trajectory of the flame of the burner 41, and all the trajectory of the flame is equally spaced over the entire side portion of the optical fiber preform 1.

Condition (m) of FIG. 5 illustrates the values of Equations (2), (4), and (5) when the offset x=−0.27, and FIG. 6B illustrates a developed view of the trajectory of the flames of the burners 41 to 44 when the offset x=−0.27. In the condition (m) of FIG. 5, the values of the Equation (2) and the Equation (4) are 8.56 and 6.03, respectively, and the value of the Equation (5) is 0.70. Therefore, the distance between the trajectory of the flame of the burner 41 and the trajectory of the flame of the burner 42 becomes large, and the distance between the trajectory of the flame of the burner 41 and the trajectory of the flame of the burner 44 becomes small. In FIG. 6B, the distance D4 is smaller than the distance D2.

Condition (n) of FIG. 5 illustrates the values of Equations (2), (4), and (5) when the offset x=−0.29, and FIG. 6C illustrates a developed view of the trajectory of the flames of the burners 41 to 44 when the offset x=−0.29. In the condition (n) of FIG. 5, the values of the Equation (2) and the Equation (4) are 9.07 and 4.61, respectively, and the value of the Equation (5) is 0.51. The distance between the trajectory of the flame of the burner 41 and the trajectory of the flame of the burner 42 becomes larger than in the case of the condition (m) of FIG. 5, and the distance between the trajectory of the flame of the burner 41 and the trajectory of the flame of the burner 44 becomes smaller. In FIG. 6C, the distance D4 is further smaller than the distance D2, and the unevenness of the surface of the optical fiber preform 1 may be increased.

Condition (h) of FIG. 5 illustrates the values of Equations (2), (4), and (5) when the offset x=−0.21, and FIG. 6D illustrates a developed view of the trajectory of the flames of the burners 41 to 44 when the offset x=−0.21. In condition (h) of FIG. 5, the values of Equation (2) and Equation (4) are 6.58 and 11.59, respectively, and the value of Equation (5) is 1.76. The distance between the trajectory of the flame of the burner 41 and the trajectory of the flame of the burner 42 is small, and the distance between the trajectory of the flame of the burner 41 and the trajectory of the flame of the burner 44 is large. In FIG. 6D, the distance D4 is larger than the distance D2, and the unevenness of the surface of the optical fiber preform 1 may increase.

Thus, when the number of burners N is 4, the value of the offset x is preferably ±1/N=±0.25, that is, the value of the Equation (5) is preferably 1.00. The unevenness of the surface of the optical fiber preform 1 may be in an acceptable range even if the value of the Equation (5) is in the range of 3/4 to 4/3 (0.75 to 1.33) or in the range of 2/3 to 3/2 (0.67 to 1.50). Therefore, when Equation (5) is a value in the range of 3/4 to 4/3 (0.75 to 1.33), the following is derived.

$$\frac{3}{3 N + 1} < \vert x \vert < \frac{4}{4 N - 1}$$

When Equation (5) is a value in the range of 2/3 to 3/2 (0.67 to 1.50), the following is derived.

$$\frac{2}{2 N + 1} < \vert x \vert < \frac{3}{3 N - 1}$$

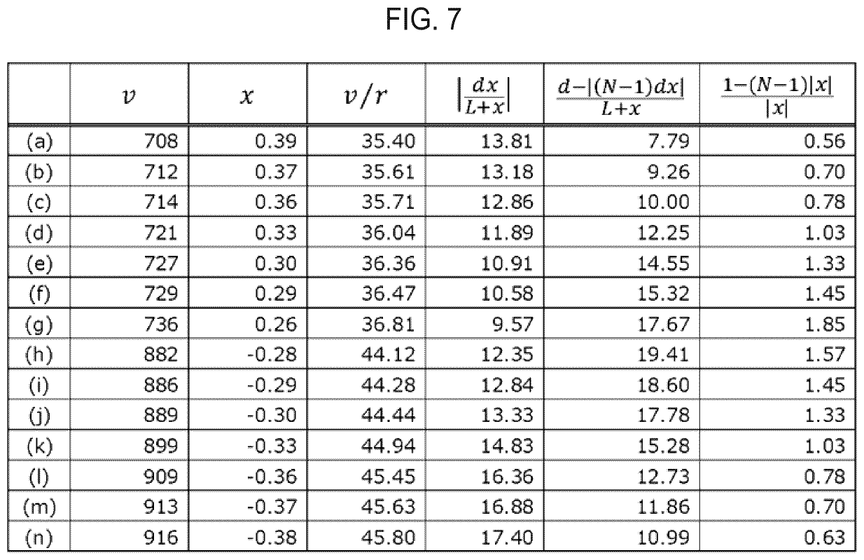

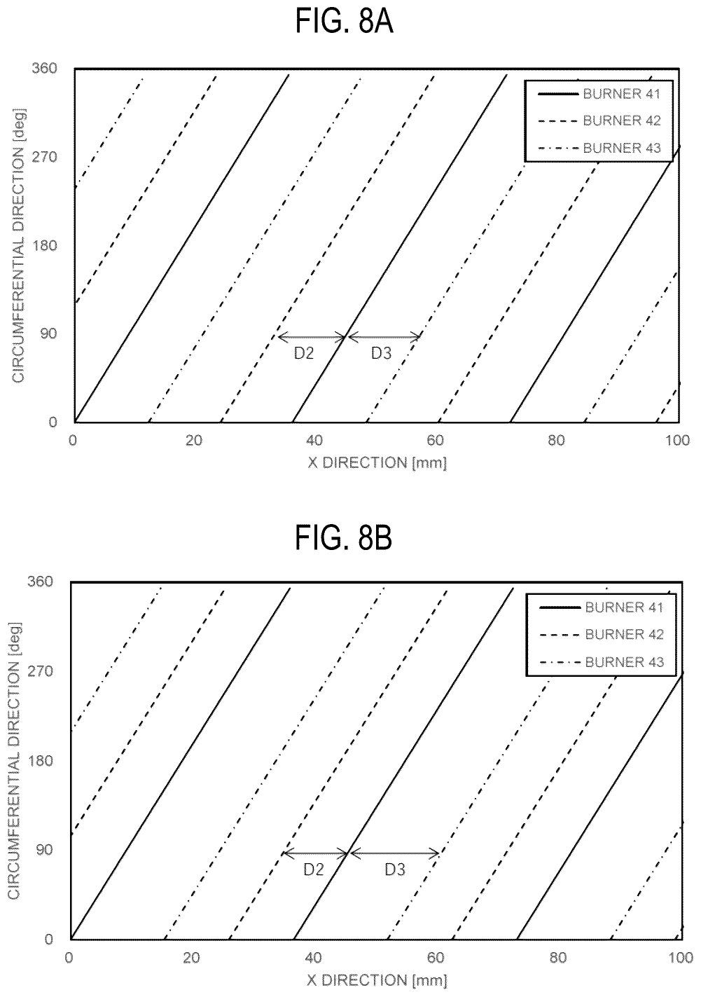

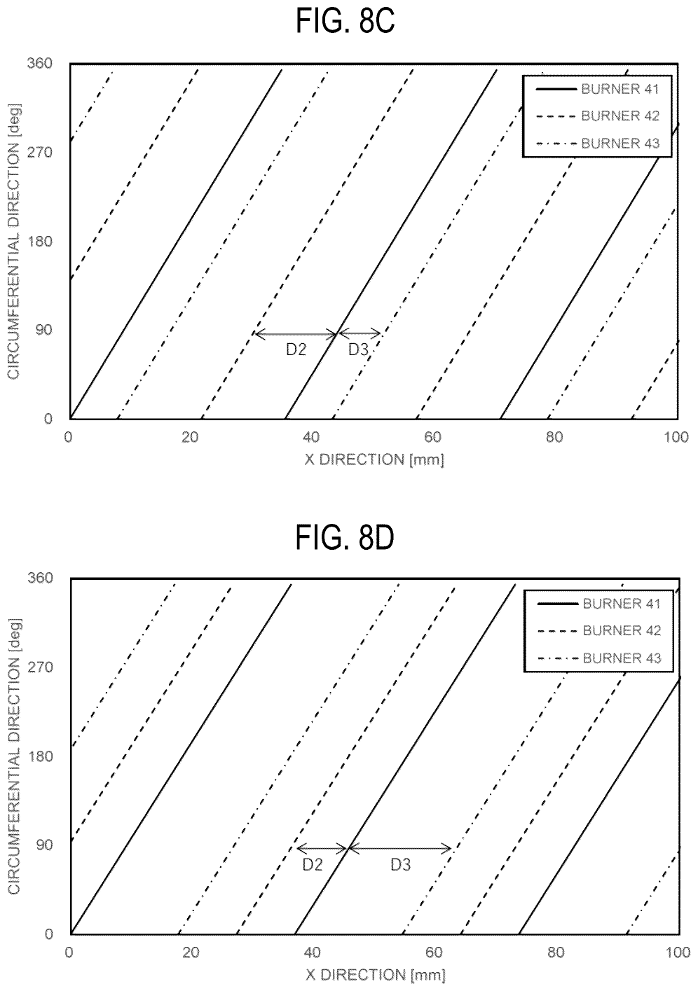

FIG. 7 is a diagram illustrating the distance of the trajectory of the flame of the burner with respect to the manufacturing conditions of the optical fiber preform in the present embodiment, and illustrates the value of the moving speed v [mm/min] of the burner array 4, the value of the offset x, the value of the moving distance v/r of the burner array 4 in the X direction when the optical fiber preform 1 makes one rotation, the value of Equation (2) (distance between the trajectory of the flame of the burner 41 and the trajectory of the flame of the burner 42), the value of Equation (4) (distance between the trajectory of the flame of the burner 41 and the trajectory of the flame of the burner 43), and the value of Equation (5), when the rotation number L=3, the number of burners N=3, the distance d=120 [mm] between the burners, and the rotation speed r=20 [rpm] of the optical fiber preform 1. FIGS. 8A to 8D are developed views of the trajectory of the flame of the burners 41 to 43 formed on the side portions of the optical fiber preform 1 in the present embodiment.

In FIG. 7, when the value of the offset x is 0.39 to 0.26 and −0.28 to −0.38, the moving speed v is 708 to 736 [mm/min] and 882 to 916 [mm/min], respectively. When the value of the offset x is 0.39 to 0.26 and −0.28 to −0.38, the distance by which the burner array 4 moves in the X direction when the optical fiber preform 1 makes one rotation is 35.40 to 36.81 [mm] and 44.12 to 45.80 [mm], respectively.

Condition (d) of FIG. 7 illustrates the values of Equations (2), (4), and (5) when the offset x=0.33, and FIG. 8A illustrates a developed view of the trajectory of the flames of the burners 41 to 43 when the offset x=0.33. In the condition (d) of FIG. 7, the values of the Equation (2) and the Equation (4) are 11.89 and 12.25, respectively, and the value of the Equation (5) is 1.03. Therefore, the distance between the trajectory of the flame of the burner 41 and the trajectory of the flame of the burner 42 is substantially equal to the distance between the trajectory of the flame of the burner 41 and the trajectory of the flame of the burner 43. In FIG. 8A, the distance D2 between the trajectory of the flame of the burner 41 and the trajectory of the flame of the burner 42 is substantially equal to the distance D3 between the trajectory of the flame of the adjacent burner 43 and the trajectory of the flame of the burner 41, and all the trajectory of the flame is substantially equally spaced over the entire side portion of the optical fiber preform 1.

Condition (f) of FIG. 7 illustrates the values of Equations (2), (4), and (5) when the offset x=0.29, and FIG. 8B illustrates a developed view of the trajectory of the flames of the burners 41 to 43 when the offset x=0.29. In condition (f) of FIG. 7, the values of Equation (2) and Equation (4) are 10.58 and 15.32, respectively, and the value of Equation (5) is 1.45. Therefore, the distance between the trajectory of the flame of the burner 41 and the trajectory of the flame of the burner 42 becomes large, and the distance between the trajectory of the flame of the burner 41 and the trajectory of the flame of the burner 43 becomes small. In FIG. 8B, the distance D2 is slightly smaller than the distance D3.

Condition (a) of FIG. 7 illustrates the values of Equations (2), (4), and (5) when the offset x=0.39, and FIG. 8C illustrates a developed view of the trajectory of the flames of the burners 41 to 43 when the offset x=0.39. In condition (a) of FIG. 7, the values of Equation (2) and Equation (4) are 13.81 and 7.79, respectively, and the value of Equation (5) is 0.56. The distance between the trajectory of the flame of the burner 41 and the trajectory of the flame of the burner 42 becomes larger than the case of the condition (f) of FIG. 7, and the distance between the trajectory of the flame of the burner 41 and the trajectory of the flame of the burner 43 becomes smaller. In FIG. 8C, the distance D3 is smaller than the distance D2, and the unevenness of the surface of the optical fiber preform 1 may increase.

Condition (g) of FIG. 7 illustrates the values of Equations (2), (4), and (5) when the offset x=0.26, and FIG. 8D illustrates a developed view of the trajectory of the flames of the burners 41 to 43 when the offset x=0.26. In the condition (g) of FIG. 7, the values of the Equation (2) and the Equation (4) are 9.57 and 17.67, respectively, and the value of the Equation (5) is 1.85. The distance between the trajectory of the flame of the burner 41 and the trajectory of the flame of the burner 42 is small, and the distance between the trajectory of the flame of the burner 41 and the trajectory of the flame of the burner 43 is large. In FIG. 8D, the distance D3 is larger than the distance D2, and the unevenness of the surface of the optical fiber preform 1 may be increased.

When the number of burners N is 3, the value of the offset x is preferably ±1/N=±0.33, that is, the value of the Equation (5) is preferably about 1.00. In addition, the unevenness of the surface of the optical fiber preform 1 may be within an acceptable range even if the value of the Equation (5) is in the range of 3/4 to 4/3 (0.75 to 1.33) or in the range of 2/3 to 3/2 (0.67 to 1.50). Therefore, when Equation (5) is a value in the range of 3/4 to 4/3 (0.75 to 1.33), the following is derived.

$$\frac{3}{3 N + 1} < \vert x \vert < \frac{4}{4 N - 1}$$

When Equation (5) is a value in the range of 2/3 to 3/2 (0.67 to 1.50), the following is derived.

$$\frac{2}{2 N + 1} < \vert x \vert < \frac{3}{3 N - 1}$$

When the absolute value of the offset x becomes larger than ±1/N, the distance between the trajectory of the flame of the burner 41 and the trajectory of the flame of the burner 42 (distance D2 in FIGS. 6A-6D and distance D2 in FIGS. 8A-8D) becomes large, and the distance between the trajectory of the flame of the burner 41 and the trajectory of the flame of the burner 4N (distance D4 in FIGS. 6A-6D and distance D3 in FIGS. 8A-8D) becomes small. On the other hand, when the absolute value of the offset becomes smaller than ±1/N, the distance between the trajectory of the flame of the burner 41 and the trajectory of the flame of the burner 42 (distance D2 in FIGS. 6A-6D and distance D2 in FIGS. 8A-8D) becomes small, and the distance between the trajectory of the flame of the burner 41 and the trajectory of the flame of the burner 4N (distance D4 in FIGS. 6A-6D and distance D3 in FIGS. 8A-8D) becomes large. Therefore, by setting an appropriate value of the offset x according to the number of burners N, it is possible to manufacture an optical fiber preform having a small surface roughness.

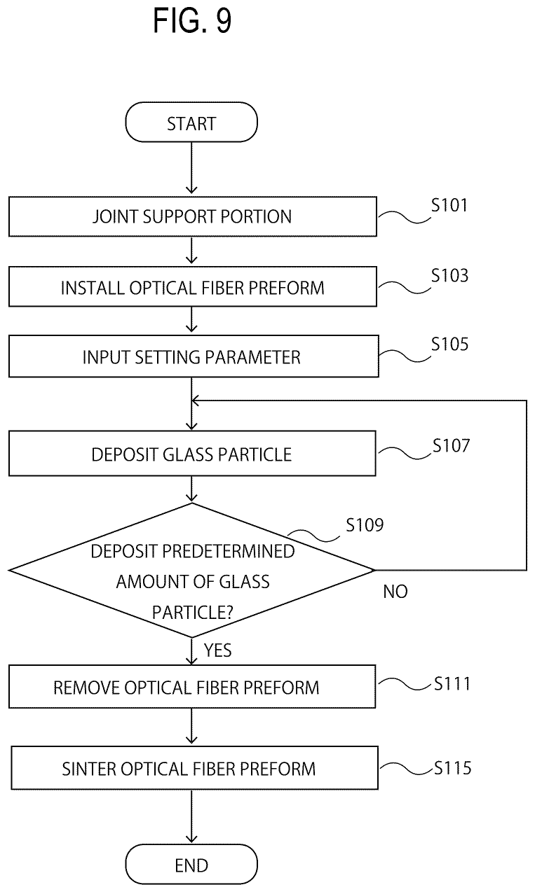

FIG. 9 is a flowchart of a method for manufacturing the optical fiber preform and an optical fiber according to the embodiment. First, the support portions 12A and 12B are jointed to both ends of the core portion 11 (step S101). The support portions 12A and 12B are melt-bonded to the core portion 11 by using an oxyhydrogen burner or the like so that the virtual support axes of the support portions 12A and 12B and the virtual core axis of the core portion 11 are positioned on substantially the same line.

Next, the core portion 11 (the optical fiber preform 1) to which the support portions 12A and 12B are bonded is installed in the deposition apparatus 2 (step S103). The support portions 12A and 12B are held by the holding portions 23 of the deposition apparatus 2, respectively.

When the operator inputs setting parameters such as the rotation number L, the burner number N, the distance d between the burners, the rotation speed r of the optical fiber preform 1, and the offset x to the control device 3 via the input device 307 (step S105), the CPU 301 substitutes the setting parameters into Equation (1) to calculate the moving speed v of the burner array 4, and transmits the setting parameters and the moving speed v to the deposition apparatus 2. For example, when the operator inputs the number of rotation number L=5, the number of burners N=4, the distance d=150 [mm] between the burners, the rotation speed r=30 [rpm] of the optical fiber preform 1, and the offset x=0.25 (in the case of the parameters of FIG. 5D), the CPU 301 calculates the moving speed v=857 [mm/min] of the burner array 4, and transmits the input setting parameters and the moving speed v to the deposition apparatus 2. The offset x may be automatically set to an appropriate value according to the number of burners N. The rotation number L may be automatically set to an appropriate value in accordance with the number of burners N, the distance d between the burners, or the like, or may be determined in accordance with the deposition density of the porous glass portion 13, the time required for the deposition process, or the like. Although the operator sets the rotation speed r in S105 and the CPU 301 calculates the moving speed v, the operator may set the moving speed v and the CPU 301 may calculate the rotation speed r.

Based on the input setting parameters in S105 and the moving speed v, the deposition apparatus 2 rotates the optical fiber preform 1 at the rotation speed r, the glass material, the flammable gas, and the supporting gas are supplied to the burner array 4, and the glass particles are deposited on the side portion of the core portion 11 by the burner array 4 (step S107). The burner array 4 reciprocates in the X direction at a moving speed v from a joint portion between the support portion 12A and the core portion 11 to a joint portion between the support portion 12B and the core portion 11. The burners 41 to 4N inject the glass material into the flame, and the generated glass particles are deposited on the side portions of the core portion 11 at intervals based on the setting parameters.

Until a predetermined amount of glass particles are deposited on the side portion of the core portion 11 (NO in step S109), burner array 4 reciprocates in the X direction at moving speed v in the lower portion of the core portion 11, and the glass particles are deposited on the side portion of core portion 11. When a predetermined amount of glass particles is deposited on the side portion of core portion 11 (YES in step S109), the supply of the glass material, the flammable gas, and the supporting gas to burner array 4 is stopped, and burner array 4 is extinguished. The deposition of the predetermined amount of glass particles may be determined by, for example, the thickness of the porous glass portion 13 in the Y direction or the Z direction, the mass difference between the optical fiber preform 1 before the deposition and after the deposition, or the like.

When the temperature of the optical fiber preform 1 is lowered to a predetermined temperature by natural cooling, the support portions 12A and 12B are removed from the holding portion 23, and the optical fiber preform 1 is removed from the deposition apparatus 2 (step S111).

The support portion 12A is vertically supported in the upper portion of a sintering apparatus, and the optical fiber preform 1 is installed in the sintering apparatus. The optical fiber preform 1 is heated and sintered by the sintering apparatus (step S115). First, chlorine (Cl₂) or the like is introduced into the furnace tube of the sintering apparatus from the gas introduction portion. Next, the optical fiber preform 1 is heated by a heater while rotating in the furnace tube. As a result, impurities or the like contained in the optical fiber preform 1 are removed. Further, chlorine is discharged to the outside of the furnace tube, and a mixed gas of chlorine and an inert gas is introduced into the furnace tube as an atmosphere gas. The optical fiber preform 1 is heated to a predetermined temperature by the heater while rotating in the furnace tube. The predetermined temperature may be, for example, 1500° C. When sintering of the optical fiber preform 1 is completed, helium is discharged to the outside of the furnace tube, and the transparently vitrified optical fiber preform 1 is taken out of the furnace tube. In the subsequent step, the transparently vitrified optical fiber preform 1 is heated and drawn. For example, the optical fiber preform 1 is heated at a heating temperature of 2000 to 2300° C. In this way, an optical fiber is formed.

As described above, according to the present embodiment, by defining the relationship between the moving speed of the burner array including a plurality of burners and the rotation speed of the core rod, the deposition efficiency is better than the deposition of the glass particles by one burner, and the unevenness of the surface of the optical fiber preform can be reduced.

### Second Embodiment

In the present embodiment, when the burner array repeats reciprocating movement, the initial phase of the rotation angle of the core rod is controlled. Hereinafter, the present embodiment will be described focusing on a configuration different from that of the first embodiment. The same components as those of the first embodiment are denoted by the same reference numerals, and description thereof will be omitted or simplified.

In step S107 of FIG. 9, the burner array 4 deposits glass particles on the side portion of the core portion 11 while moving from one end portion to the other end portion of the optical fiber preform 1 in the X direction. The control device 3 stores the initial phase θ1 of the rotation angle of the optical fiber preform 1 when the burner array 4 starts moving from one end portion. Such a series of steps is referred to as a first forward path deposition step.

After the burner array 4 moves to the other end portion of the optical fiber preform 1, the burner array 4 deposits glass particles on the side portion of the core portion 11 while moving from the other end portion to the one end portion of the optical fiber preform 1. The control device 3 stores the initial phase θ2 of the rotation angle of the optical fiber preform 1 when the burner array 4 starts moving from the other end portion. Such a series of steps is referred to as a first return path deposition step.

When the burner array 4 moves to one end of the optical fiber preform 1, the burner array 4 starts moving from one end of the optical fiber preform 1. At this time, the control device 3 controls the initial phase θ3 of the rotation angle of the optical fiber preform 1 to a value different from the initial phase θ1. For example, the difference between the initial phase θ1 and the initial phase θ3 may be less than the absolute value of the offset x, which is greater than 0. That is, the initial phase θ3 may be set so that the trajectory of the flame of the burner 41 in the current deposition process is formed between the trajectory of the flame of the burner 41 formed in the first forward path deposition process and the trajectory of the flame of the burner 42 formed in the first forward path deposition process. When the burner array 4 moves to the other end of the optical fiber preform 1 based on the initial phase θ3, the burner array 4 temporarily stops the deposition of the glass particles. Such a series of steps is referred to as a second forward path deposition step.

When the burner array 4 moves to the other end of the optical fiber preform 1, the burner array 4 starts moving from the other end of the optical fiber preform 1. At this time, the control device 3 controls the initial phase θ4 of the rotation angle of the optical fiber preform 1 to a value different from the initial phase θ2. For example, the difference between the initial phase θ2 and the initial phase θ4 may be less than the absolute value of the offset x, which is greater than 0. That is, the initial phase θ4 may be set so that the trajectory of the flame of the burner 4N in the current deposition process is formed between the trajectory of the flame of the burner 4N formed in the first return path deposition process and the trajectory of the flame of the burner 4(N−1) formed in the first return path deposition process. When the burner array 4 moves to one end of the optical fiber preform 1 based on the initial phase θ4, the burner array 4 temporarily stops the deposition of the glass particles. Such a series of steps is referred to as a second return path deposition step.

As in the second forward path deposition step, when the burner array 4 moves to one end of the optical fiber preform 1, the burner array 4 starts moving from one end of the optical fiber preform 1. At this time, the control device 3 controls the initial phase θ5 of the rotation angle of the optical fiber preform 1 to a value different from the initial phase θ3. For example, the difference between the initial phase θ3 and the initial phase θ5 may be greater than 0 and less than the absolute value of the offset x. That is, the initial phase θ5 may be set so that the trajectory of the flame of the burner 41 in the current deposition process is formed between the trajectory of the flame of the burner 41 formed in the second forward path deposition process and the trajectory of the flame of the burner 42 formed in the first forward path deposition process. When the burner array 4 moves to the other end of the optical fiber preform 1 based on the initial phase θ5, the burner array 4 temporarily stops the deposition of the glass particles. Such a series of steps is referred to as a third forward path deposition step.

The glass particles are deposited by the burner array 4 to form the optical fiber preform 1 by adding a predetermined angle to the initial phase for each deposition step at one end portion and the other end portion, and repeating the deposition step as described above. In the present embodiment, the initial phase of the burner array 4 is set for each deposition step, and the burner array 4 deposits glass particles on the side portion of the core portion 11. The predetermined angle may be calculated based on the number of times of the deposition process in which the predetermined deposition amount is obtained in S109, or may be determined based on the distribution of the deposition amount of the glass particles of the burners 41 to 4N. The predetermined angle to be added to the initial phase at one end of the optical fiber preform 1 may be the same as the predetermined angle to be added to the initial phase at the other end, and different predetermined angles may be added to the initial phase.

In the step of depositing the glass particles from one end portion to the other end portion of the optical fiber preform 1 (forward path), the initial phase is set so that the trajectories of the flames of the burners 41 to 4N in the first forward path, the second forward path, the third forward path, . . . do not overlap each other. In the step of depositing the glass particles from the other end portion to the one end portion of the optical fiber preform 1 (return path), the initial phase is set so that the trajectories of the flames of the burners 41 to 4N in the first return path, the second return path, the third return path, . . . do not overlap each other. On the other hand, in the deposition process of the forward path and the deposition process of the return path, since the trajectory of the flame in the forward path and the trajectory of the flame in the return path intersect each other, the initial phases of them do not necessarily need to be considered.

As described above, according to the present embodiment, the relationship between the moving speed of the burner array including a plurality of burners and the rotation speed of the core rod is defined, and the initial phase of the trajectory of the flame of the burner array is set for each deposition step, whereby the deposition efficiency is better than the deposition of the glass particles by one burner, and the unevenness of the surface of the optical fiber preform can be reduced.

### Example 1

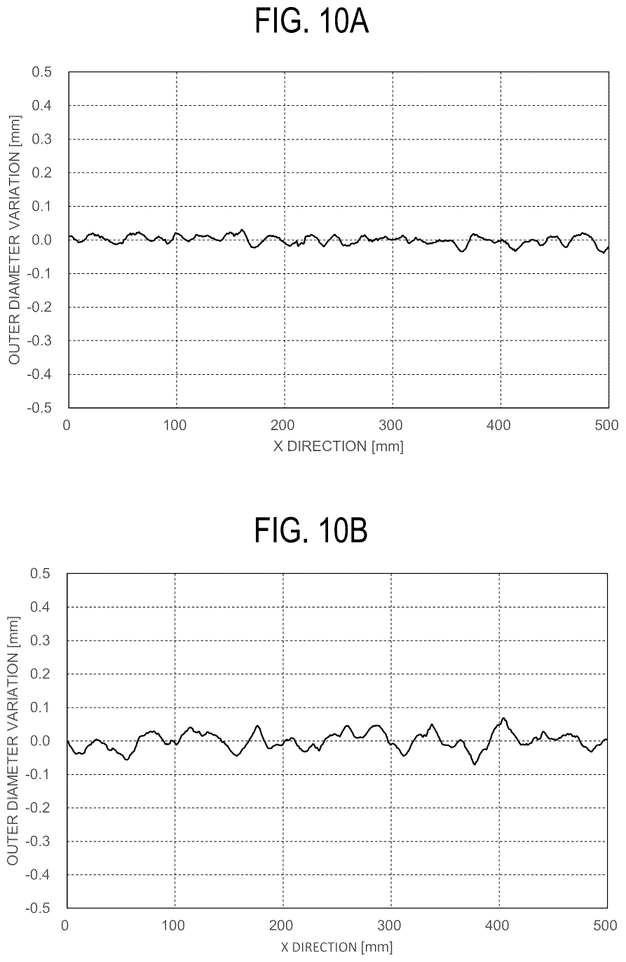

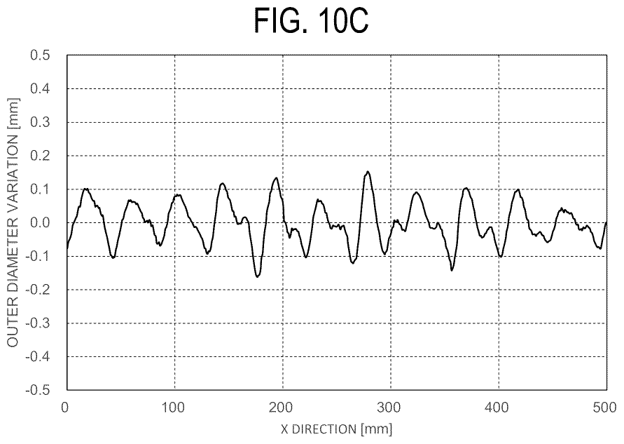

The optical fiber preform 1 was manufactured by the manufacturing method of the first embodiment under the conditions of the rotation number L=5, the number of burners N=4, the distance d=150 [mm] between burners, the rotation speed r=30 [rpm] of the optical fiber preform 1, and the offset x=−0.25 (in the case of the condition (k) of FIG. 5), and the outer diameter variation of a portion where the side portion of the optical fiber preform 1 was formed in a substantially cylindrical shape (the portion excluding the tapered portions 14A and 14B) was examined. FIG. 10A is a diagram illustrating an outer diameter variation of the optical fiber preform 1 in the present embodiment. The average thickness of the deposited porous glass portion 13 was about 200 mm. As illustrated in FIG. 10A, the outer diameter variation was −0.04 to 0.04 mm or less, and the optical fiber preform 1 having a small surface roughness could be manufactured. The standard deviation of the outer diameter variation in FIG. 10A was 1.26×10⁻² [mm].

### Example 2

The optical fiber preform 1 was manufactured by the manufacturing method of the first embodiment under the conditions of the rotation number L=5, the number of burners N=4, the distance d=150 [mm] between burners, the rotation speed r=30 [rpm] of the optical fiber preform 1, and the offset x=−0.27 (in the case of the condition (m) of FIG. 5), and the outer diameter variation of a portion where the side portion of the optical fiber preform 1 was formed in a substantially cylindrical shape was examined. FIG. 10B is a diagram illustrating an outer diameter variation of the optical fiber preform 1 in the present embodiment. The average thickness of the deposited porous glass portion 13 was about 200 mm. As illustrated in FIG. 10B, the outer diameter variation was −0.07 to 0.07 mm or less, and the optical fiber preform 1 having a small surface roughness could be manufactured. In the present embodiment, the value of the Equation (5) is 0.70, and the unevenness of the surface of the optical fiber preform 1 is within an acceptable range when the value of the Equation (5) is within a range of 2/3 to 3/2 (0.67 to 1.50). The standard deviation of the outer diameter variation in FIG. 10B was 2.53×10⁻² [mm].

### COMPARATIVE EXAMPLE

On the other hand, as a Comparative Example, the optical fiber preform 1 was manufactured by the manufacturing method of the first embodiment under the conditions of the rotation number L=5, the number of burners N=4, the distance d=150 [mm] between burners, the rotation speed r=30 [rpm] of the optical fiber preform 1, and the offset x=−0.29 (in the case of the condition (n) of FIG. 5), and the outer diameter variation of a portion where the side portion of the optical fiber preform 1 was formed in a substantially cylindrical shape was examined. FIG. 10C is a diagram illustrating an outer diameter variation of the optical fiber preform 1 in the present embodiment. The average thickness of the deposited porous glass portion 13 was about 200 mm. As illustrated in FIG. 10C, the outer diameter variation was −0.17 to 0.17 mm or less, and a variation exceeding 0.1 mm occurred in part. In this Comparative Example, the value of the Equation (5) was 0.51, and when the value of the Equation (5) was outside the range of 2/3 to 3/2 (0.67 to 1.50), the unevenness of the surface of the optical fiber preform 1 was large. The standard deviation of the outer diameter variation in FIG. 10C was 6.22×10⁻² [mm].

In Example 1 and Example 2, it was found that when the value of the Equation (5) is within the range of 2/3 to 3/2 (0.67 to 1.50), the variation in the outer diameter variation of the optical fiber preform 1 can be suppressed to 0.05% or less. On the other hand, in the Comparative Example, it was found that when the value of the Equation (5) is outside the range of 2/3 to 3/2 (0.67 to 1.50), the outer diameter variation of the optical fiber preform 1 is greater than 0.05%.

What is claimed is:

1. An apparatus for manufacturing an optical fiber preform comprising:
a support portion rotating a core rod at a rotation speed r around a rotation axis of the core rod extending in a longitudinal direction of the core rod; and
at least one burner array including N sets (N is an integer of 2 or more) of burners provided at intervals of a distance d and a material ejection port, and moving around the core rod at a speed v in the longitudinal direction to form a porous glass portion on an outer periphery of the core rod,
wherein a rotation number (L+x) of the core rod when the burner array moves the distance d in the longitudinal direction is represented by,
$$\frac{rd}{v} = L + x$$
where the L is an arbitrary natural number and an offset x is greater than −0.5 and less than or equal to 0.5, an absolute value of the offset x is represented by,
$$\frac{2}{2 N + 1} < \vert x \vert < \frac{3}{3 N - 1} .$$

2. The apparatus for manufacturing the optical fiber preform according to claim 1, wherein the absolute value of the offset x is represented by,
$$\frac{3}{3 N + 1} < \vert x \vert < \frac{4}{4 N - 1} .$$

3. The apparatus for manufacturing the optical fiber preform according to claim 1, wherein an absolute value of the offset is further represented by,
$$x = \pm \frac{1}{N} .$$

4. The apparatus for manufacturing the optical fiber preform according to claim 1, wherein when one of the speed v or the rotation speed r is determined, the other is determined.

5. The apparatus for manufacturing the optical fiber preform according to claim 1,
wherein the burner array is capable of repeatedly performing a movement from one end of the core rod to the other end of the core rod, and
wherein a first initial phase of a rotation angle of the core rod when starting a first movement and a second initial phase of a rotation angle of the core rod when starting a second movement following the first movement are different from each other.

6. The apparatus for manufacturing the optical fiber preform according to claim 5, wherein a difference between the first initial phase and the second initial phase is greater than 0 and less than an absolute value of the offset x.

7. A method for manufacturing the optical fiber preform comprising:
forming a porous glass portion on an outer periphery of a core rod with at least one burner array,
wherein the core rod rotates at a rotation speed r around a rotation axis of the core rod extending in a longitudinal direction of the core rod,
wherein the burner array includes N sets (N is an integer of 2 or more) of burners provided at intervals of a distance d and a material ejection port, and moves around the core rod at a speed v in the longitudinal direction,
wherein a rotation number (L+x) of the core rod when the burner array moves the distance d in the longitudinal direction is represented by,
$$\frac{rd}{v} = L + x$$
where the L is an arbitrary natural number and an offset x is greater than −0.5 and less than or equal to 0.5, an absolute value of the offset x is rep resented by,
$$\frac{2}{2 N + 1} < \vert x \vert < \frac{3}{3 N - 1} .$$

8. An optical fiber preform manufactured by the apparatus for manufacturing the optical fiber preform according to claim 1.

9. An optical fiber manufactured by drawing the optical fiber preform according to claim 8 at a high temperature.
